(19) United States
(12) Patent Application Publication
(10) Pub. No.: US 2021/0291225 A1
(43) Pub. Date: Sep. 23, 2021

(54) TWO-COAT TWO-BAKE POWDER COATING STRUCTURE AND APPLICATION METHOD THEREOF

(71) Applicant: GUO HONG SHI YE CO., LTD., Taichung City (TW)

(72) Inventor: CHENG CHIEH CHEN, TAICHUNG CITY (TW)

(21) Appl. No.: 16/994,851

(22) Filed: Aug. 17, 2020

(30) Foreign Application Priority Data
Mar. 18, 2020 (TW) 109108972

(51) Int. Cl. B05D 7/00; C09D 5/03; C08K 5/00; B05D 1/06; B05D 5/02

(52) U.S. Cl. CPC B05D 7/546; C09D 5/035; C09D 5/032; B05D 2202/00; B05D 1/06; B05D 5/02; C08K 2201/003; C08K 5/0041

(57) ABSTRACT

The present invention relates to a two-coat two-bake powder coating structure and application method thereof that mainly utilizes high concentrated migratory pigment and dye powder in the primer layer that osmotically diffuses into the finish layer of colorless powder during baking after the finish layer undergoes the electrostatic spray process. The principle is to apply a second baking process to the migratory pigment and dye powder, causing the molecular chains of the primer layer to become loose. As a result, the small molecules of the migratory pigment and dye powder can uniformly move from the primer layer into the finish layer across the interface between the primer layer and the finish layer through osmosis and diffusion. After the finish layer cools down, the migratory pigment and dye powder is solidified within the finish layer so that the chromatic aberration of the surface coating layer is improved.

### BACKGROUND OF THE INVENTION

### 1. Fields of the Invention

The present invention relates to a technical field of powder coating, more specifically, the technical scope of a two-coat two-bake powder coating structure and application method thereof.

### 2. Descriptions of Related Art

With higher demands of people for aesthetic, the pursuit of coatings of great aesthetic has become a trend itself. Powder coatings having metallic texture, a pearlescent effect or a color effect, can display a luxurious decoration effect from crystal-like metallic luster to silky satin-like pearlescent brightness, and therefore are widely applied to the spray coating processes for furniture, home decoration accessories and sports equipment.

The coating methods of a metal substrate generally need to undergo two-coat two-bake procedures in the past. The procedure is to apply a primer layer to seal the substrate base, add pigment and dye powder to the finish coating material. After the finish coating material is applied to the primer layer, the substrate is baked so that the finish layer is adhesive on the primer layer in order to achieve the color effect of two-coat two-bake coatings.

However, the aforementioned finish layer appears easily to have chromatic aberration phenomena due to an uneven thickness of a coating film. As a result, the edge area of a metal substrate where the coating paint sags generates chromatic aberrations due to accumulated coloring material of the finish layer. Thus, there is apparently a need of improvement in the two-coat two-bake powder coating structure processing of the prior art.

### SUMMARY OF THE INVENTION

In view of the aforementioned existing problems of the two-coat two-bake powder coating of the prior art, therefore, the inventor of the present invention investigated the aforementioned problems and searched intensively for the solutions thereof. Thus, the two-coat two-bake powder coating structure and application method thereof is invented. The main objective of the present invention is to provide a two-coat two-bake powder coating structure that does not generate chromatic aberration phenomena due to an uneven thickness of a coating film; the secondary objective of the present invention is to provide a two-coat two-bake powder coating structure that does not generate chromatic aberration phenomena at the edge area of a metal substrate where the coating paint sags due to accumulated coloring material of the finish layer.

To achieve the aforementioned objectives, the following technical means are implemented:

The two-coat two-bake powder coating structure of the present invention comprises: a primer layer, which is created by having the primer powder added with migratory pigment and dye powder to be coated on the surface of a metal substrate through the electrostatic spray process and later is formed during the first baking process, and a finish layer, which is created by means of applying the finish powder on the surface of the primer layer through electrostatic spray coating, then having the migratory pigment and dye powder in the primer layer uniformly and osmotically diffusing into the finish layer during the second baking process, due to the temperature of the finish layer being greater than that of the primer layer after the first baking process and the density of the primer layer to be greater than that of the finish layer; last, the finish layer and the primer layer are solidified after being cooled down.

The primer layer is composed of 45%˜99% powder coating resins, 0.5%˜2% leveling agents, 3%˜10% hardeners, 0.1%˜15% migratory pigment and dye powder, 0.2%˜1.5% defoamers, and 0.1%˜40% fillers to make up 100% of the composition of the primer coating.

The finish layer is composed of 90%˜99% powder coating resins, 0.5%˜2% leveling agents, 3%˜10% hardeners, 0%˜10% brighteners, and 0.2%˜1.5% defoamers to make up 100% of the composition of the finish coating.

The migratory pigment and dye powder is set to be organic pigment and dye powder of small molecules with a particle diameter between 0.01 um˜10 um and a molecular weight between 180˜1000.

The application method of the aforementioned two-coat two-bake powder coating structure comprises: a pigment and dye powder adding step, which adds migratory pigment and dye powder in the base powder to form a primer powder; a primer powder coating step, which coats the primer powder on the metal surface through electrostatic spray coating; a first baking step, wherein the primer powder is baked to form a primer layer, having the baking temperature set between 120˜200° C. for a duration of 5˜20 minutes; a finish powder coating step, which coats the finish powder on the surface of the primer layer through electrostatic spray coating; and a second baking step, wherein the migratory pigment and dye powder in the primer layer can move into the finish layer across the interface between the primer layer and the finish layer, while the finish powder being baked, and is solidified to form a finish layer after cooling, and the baking temperature is set to be 130° C.˜240° C. and above for a duration of 5˜20 minutes;

wherein the primer powder coating step sets the primer layer structure of the primer powder coated on the metal surface through electrostatic spray coating to be a surface having a flat, wrinkled, drape, or sand ripple structure;

wherein the second baking step is to produce a bright, flat, matt, transparent, or translucent finish layer by adjusting different ratios of brighteners.

The present invention applies the aforementioned technical means to achieve the following effectiveness:

1. The present invention is to create a method for molecules of the migratory pigment and dye powder in the primer layer to uniformly and osmotically diffuse into the finish layer during the operation of baking the finish layer and later for the finish layer to form a surface coating without chromatic aberrations after cooling and being solidified.

2. The present invention is to create a method that even with coating paint sagged in the edge area of a metal substrate due to accumulated coloring material of the finish layer during the operation of baking the finish layer, the coating does not generate chromatic aberration phenomena.

### BRIEF DESCRIPTION OF THE DRAWINGS

FIG. 1: The schematic diagram of the two-coat two-bake powder coating structure of the present invention;

FIG. 2: The schematic diagram of compositions of the primer layer and finish layer of the present invention;

FIG. 3: The schematic diagram of molecules of the high concentrated migratory pigment and dye powder in the primer layer to uniformly and osmotically diffuse into the finish layer of colorless powder of the present invention;

FIG. 4: The step flow diagram of the application method of the two-coat two-bake powder coating structure of the present invention;

### DETAILED DESCRIPTION OF THE PREFERRED EMBODIMENT

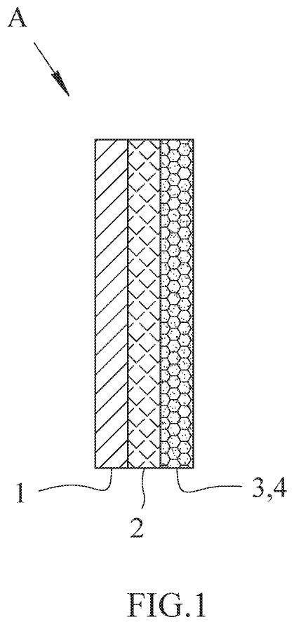

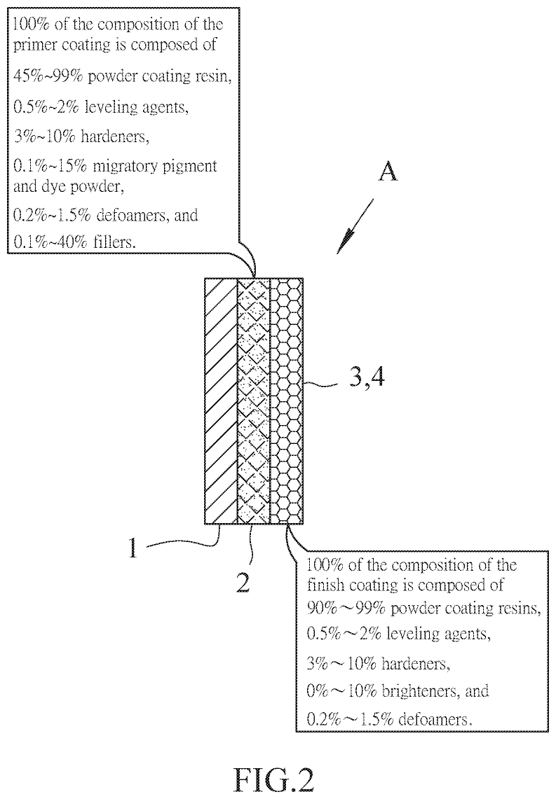

First, please refer to FIG. 1 and FIG. 2. The present invention relates to a two-coat two-bake powder coating structure A that provides coatings on a metal substrate 1, comprising a primer layer 2 and a finish layer 3.

The primer layer 2 is created by having the primer powder added with migratory pigment and dye powder 4 to be coated on the surface of a metal substrate 1 through the electrostatic spray process which sequentially undergoes a first baking process at a high temperature and later is cooled to form the primer layer 2; furthermore, the primer layer is composed of 45%˜99% powder coating resins, 0.5%˜2% leveling agents, 3%˜10% hardeners, 0.1%˜15% migratory pigment and dye powder, 0.2%˜1.5% defoamers, and 0.1%˜40% fillers to make up 100% of the composition of the primer coating; furthermore, the powder coating resins can be epoxy-based, epoxy-polyester hybrid-based, pure polyester-based, polyurethane-based (PU-based), acrylic-based, polyethylene-based (PE-based), or nylon-based powder coating resins; wherein the leveling agent can be acrylic-based, silicone-based, or fluorosurfactant-based leveling agents; wherein for powder coating resins of epoxy-polyester hybrid-based, pure polyester-based, polyethylene-based, and nylon-based powder coating resins specifically, no hardener is needed, whereas for the remaining aforementioned powder coating resins, hardeners for powder coatings including amino-based, TGIC-based, HAA-based, PU isocyanate-based, or dicarboxylic acid DDDA-based hardeners can be used; wherein the migratory pigment and dye powder is composed of small molecules of organic pigment and dye powder including dyestuffs, pigment, or flourescent pigment types of powder with a particle diameter between 0.01 um˜10 um and a molecular weight between 180˜1000; wherein the types of defoamers can be benzoin-based, wax-based, silicone-based, or fluorine-based defoamers; wherein the fillers are generally all types of inorganic metal and ore, such as aluminum powder, copper powder, pearl powder, barium sulfate, calcium carbonate, titanium dioxide powder, and clay.

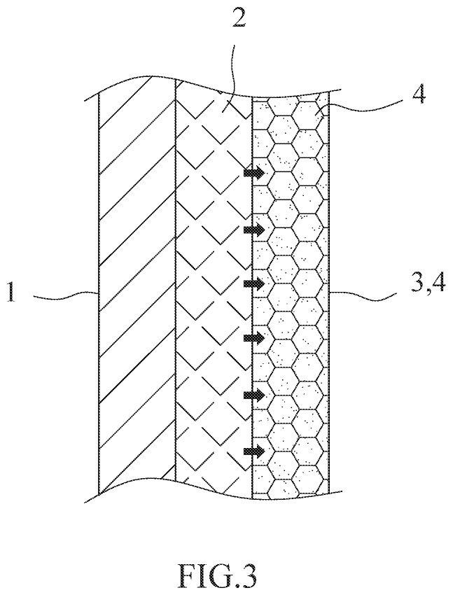

The finish layer 3 is created by means of applying the finish powder on the surface of the primer layer 2 through electrostatic spray coating, then having the migratory pigment and dye powder 4 in the primer layer 2 to uniformly and osmotically diffuse into the finish powder during the second baking process, as shown in FIG. 3; the finish layer 3 and the primer layer 2 are solidified after being cooled down; furthermore, the finish layer 3 is composed of 90%˜99% powder coating resins, 0.5%˜2% leveling agents, 3%˜10% hardeners, 0%˜10% brighteners, and 0.2%˜1.5% defoamers to make up 100% of the composition of the finish coating; furthermore, the powder coating resins can be epoxy-based, epoxy-polyester hybrid-based, pure polyester-based, PU-based, acrylic-based, PE-based, or nylon-based powder coating resins; wherein the leveling agent can be acrylic-based, silicone-based, or fluorosurfactant-based leveling agents; wherein for powder coating resins of epoxy-polyester hybrid-based, pure polyester-based, polyethylene-based, and nylon-based powder coating resins specifically, no hardener is needed, whereas for the remaining aforementioned powder coating resins, hardeners for powder coatings including amino-based, TGIC-based, HAA-based, PU isocyanate-based, or dicarboxylic acid DDDA-based hardeners can be used; wherein the brighteners can be either applied or not used at all in order to produce a bright, flat, matt, transparent, or translucent finish layer 3 by adjusting different ratios of brighteners, if applied.

The two-coat two-bake powder coating structure A of the present invention is composed of the aforementioned primer layer 2 and the aforementioned finish layer 3, as shown in FIG. 3, wherein during the baking process of the finish layer 3, the high temperature thermally propagates toward the finish layer 2; due to the temperature of the finish layer 3 being greater than that of the primer layer 2 after the first baking process and the density of the primer layer 2 to be greater than that of the finish layer 3 during the second baking process, along with the concentration of the pigment and dye powder 4 in the primer layer 2 to be higher, therefore, the pigment and dye powder 4 will uniformly and osmotically diffuse molecules of migratory pigment and dye powder 4 from the primer layer 2 into the finish layer 3 of colorless powder, and a surface coating without chromatic aberrations is formed after being cooled down and solidified. The principle is to apply a baking process to polymers, causing the molecular chains of the primer layer 2 to become loose. As a result, the small molecules of the migratory pigment and dye powder 4 can uniformly and osmotically diffuse from the primer layer 2, located below, into the finish layer 3 located above, across the interface between the primer layer 2 and the finish layer 3. With the same token, the present invention applies this principle to create a method that even with coating paint sagged in the edge area of a metal substrate 1 due to accumulated coloring material of the finish layer 3 during the operation of baking the finish layer 3, the coating does not generate chromatic aberration phenomena.

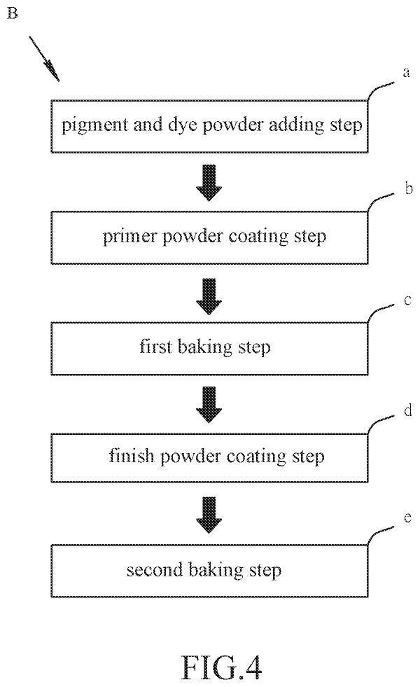

The application method B of the aforementioned two-coat two-bake powder coating structure A of the present invention, as shown in FIG. 1, FIG. 3, and FIG. 4, comprises: a pigment and dye powder adding step a, which adds migratory pigment and dye powder 4 in the base powder to form a primer powder; a primer powder coating step b, which coats the primer powder on the metal surface 1 through electrostatic spray coating; a first baking step c, wherein the primer powder is baked to form a primer layer 2, having the baking temperature set between 120˜200° C. for a duration of 5˜20 minutes; a finish powder coating step d, which coats the finish powder on the surface of the primer layer 2 through electrostatic spray coating; and a second baking step e, wherein the migratory pigment and dye powder 4 in the primer layer 2 can move into the finish powder, while the finish powder being baked and the baking temperature set to be 130° C.˜240° C. and above for a duration of 5˜20 minutes, and is solidified to form a finish layer 3 and the primer layer 2 after cooling, and as a result the surface of the metal substrate 1 has a color coating layer.

Furthermore, during the primer powder coating step b, the primer layer 2 structure of the primer powder coated on the metal surface 1 through electrostatic spray coating is set to be a surface having a flat, wrinkled, drape, or sand ripple structure; furthermore, the second baking step e produces a bright, flat, matt, transparent, or translucent finish layer 3 by adjusting different ratios of brighteners; and thus the surface of the metal substrate 1 has a color coating layer of different color variations.

In summary, the present invention relates to a two-coat two-bake powder coating structure and application method thereof. After searching domestic and foreign publications or openly available applications related to the technology of this type of structure and steps, it is concluded that no identical or similar structures nor steps exist in the patents approved prior to the submission of the application of the present invention. Thus, the present invention meets the key requirements of “novelty”, “progress” and “applicable to industrial use” for patentability and, therefore, hereby the application is submitted. The author of the patent application will be grateful for the timely review and approval of the application by the Patent and Trademark Office.

It is necessary to state that the aforementioned descriptions are the technical principles applied in embodiments of the present invention in order to explain the technological concepts and characteristics of the present invention so as to motivate those skilled in the art to better understand the contents of the present invention and to utilize the invention for various modifications as suitable for specific applications, and are not intended to limit the scope of the present invention in any way. Alternative embodiments will become apparent to those skilled in the art to which the present invention pertains without departing from its spirit and scope.

What is claimed is:

1. A two-coat two-bake powder coating structure, comprising:
a primer layer, which is created by having the primer powder added with migratory pigment and dye powder to be coated on the surface of a metal substrate through the electrostatic spray process, and later is formed during the first baking process; and
a finish layer, which is created by means of applying the finish powder on the surface of the primer layer through electrostatic spray coating, then having the migratory pigment and dye powder in the primer layer uniformly and osmotically diffusing into the finish layer during the second baking process, due to the temperature of the finish layer being greater than that of the primer layer after the first baking process and the density of the primer layer to be greater than that of the finish layer, wherein subsequently the finish layer and the primer layer are solidified after being cooled down.

2. The two-coat two-bake powder coating structure as claimed in claim 1, wherein the primer layer is composed of 45%˜99% powder coating resins, 0.5%˜2% leveling agents, 3%˜10% hardeners, 0.1%˜15% migratory pigment and dye powder, 0.2%˜1.5% defoamers, and 0.1%˜40% fillers to make up 100% of the composition of the primer coating.

3. The two-coat two-bake powder coating structure as claimed in claim 1, wherein the finish layer is composed of 90%˜99% powder coating resins, 0.5%˜2% leveling agents, 3%˜10% hardeners, 0%˜10% brighteners, and 0.2%˜1.5% defoamers to make up 100% of the composition of the finish coating.

4. The two-coat two-bake powder coating structure as claimed in claim 1, wherein the migratory pigment and dye powder is set to be organic pigment and dye powder of small molecules with a particle diameter between 0.01 um˜10 um and a molecular weight between 180˜1000.

5. An application method of the two-coat two-bake powder coating structure as claimed in claim 1, comprising:
a pigment and dye powder adding step, which adds migratory pigment and dye powder in the base powder to form a primer powder;
a primer powder coating step, which coats the primer powder on the metal surface through electrostatic spray coating;
a first baking step, wherein the primer powder is baked to form a primer layer, having the baking temperature set between 120˜200° C. for a duration of 5˜20 minutes;
a finish powder coating step, which coats the finish powder on the surface of the primer layer through electrostatic spray coating; and
a second baking step, wherein the migratory pigment and dye powder in the primer layer can move into the finish layer across the interface between the primer layer and the finish layer, while the finish powder being baked, and is solidified to form a finish layer after cooling, and the baking temperature is set to be 130° C.˜240° C. and above for a duration of 5˜20 minutes,
wherein by applying the aforementioned steps, the migratory pigment and dye powder in the primer layer can uniformly and osmotically diffuse into the finish layer during the second baking process, due to the temperature of the finish layer being greater than that of the primer layer after the first baking process and the density of the primer layer to be greater than that of the finish layer; last, the finish layer and the primer layer are solidified after being cooled down.

6. The application method of the two-coat two-bake powder coating structure as claimed in claim 5, wherein the primer powder coating step sets the primer layer structure of the primer powder coated on the metal surface through electrostatic spray coating to be a surface having a flat, wrinkled, drape, or sand ripple structure.

7. The application method of the two-coat two-bake powder coating structure as claimed in claim 5, wherein the second baking step is to produce a bright, flat, matt, transparent, or translucent finish layer by adjusting different ratios of brighteners.
